(19) United States
(12) Patent Application Publication
(10) Pub. No.: US 2011/0054928 A1
(43) Pub. Date: Mar. 3, 2011

(54) METHOD FOR PERSONALIZED NUTRITIONAL SUPPLEMENTS

(76) Inventor: Paul Sullivan, Santa Barbara, CA (US)

(21) Appl. No.: 12/871,077

(22) Filed: Aug. 30, 2010

Related U.S. Application Data
(60) Provisional application No. 61/237,856, filed on Aug. 28, 2009.

(51) Int. Cl. G06Q 50/00

(52) U.S. Cl. 705/2

(57) ABSTRACT

A personalized nutritional supplement method that includes the steps of affiliation; training; client assessment; review; recommendations; order placement; and order fulfillment. A personalized nutritional supplement method that includes blood testing is also provided.

### RELATED APPLICATIONS

This application claims the benefit of U.S. Provisional Ser. No. 61/237,856 filed on Aug. 28, 2009, which is incorporated herein by reference.

### TECHNICAL FIELD

In one or more embodiments, the present invention relates to a method for determining and providing a personalized nutritional supplement program.

### BACKGROUND OF THE INVENTION

While many of today's drugs positively impact a condition or disease, many may also negatively impact patients by disrupting critical processes or by depleting vital nutrients. The perfect drug does not exist. For all the beneficial powers that prescription medications provide, virtually all exert some negative impact to the body by either reacting with other drugs, reacting with food or nutritional supplements, blocking or inhibiting certain metabolic systems while they perform their intended healing functions, or in some cases, actually depleting critical nutrients that if not replaced, lead to escalating illness or chronic disease.

Every individual has unique nutrition needs. No two people are alike. The one size fits all nutritional products not only fail to fit everyone but fail to fit anyone.

A method for determining and providing a personalized nutritional supplement program that can improve clinical outcomes and improve health is needed.

### SUMMARY OF THE INVENTION

In one or more embodiments, the present invention provides a personalized nutritional supplement method that includes the following general steps: 1). Affiliation; 2). Training; 3). Client Assessment; 4). Review; 5). Recommendations 6). Order Placement; and 7). Order fulfillment.

In one or more embodiments, the present invention further provides a personalized nutritional supplement method that includes the following general steps: 1). Company enrollment; 2). Employee participant assessment; 3). Preliminary review; 4). Participant blood test and analysis; 5). Full review; 6). Recommendations 7). Order Placement; and 8). Order fulfillment.

### BRIEF DESCRIPTION OF THE DRAWINGS

FIG. 1 shows a flow chart for a method of determining personalized nutritional needs and providing a personalized nutritional supplement program with the consultation of a health professional according to one embodiment of the invention.

FIG. 2 illustrates a webpage showing Preliminary Nutritional Results.

FIG. 3 illustrates a webpage showing Nutritional Supplement Recommendations.

FIG. 4 shows a flow chart for a method of determining personalized nutritional needs and providing a personalized nutritional supplement program which can be ordered online by consumers.

FIG. 5 shows a flow chart for a method of determining personalized nutritional needs and providing a personalized nutritional supplement program according to one embodiment of the invention.

### DETAILED DESCRIPTION OF ILLUSTRATIVE EMBODIMENTS

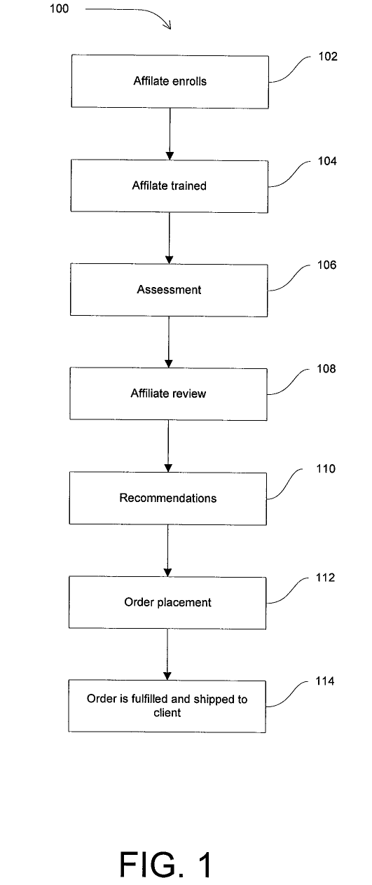

In one or more embodiments, the present invention provides a personalized nutritional supplement method 100, outlined in general in FIG. 1, that includes the following general steps: 1). Affiliation 102; 2). Training 104; 3). Client Assessment 106; 4). Generating Review 108; 5). Recommendations 110; 6). Order Placement 112; and 7). Order fulfillment 114.

In one or more embodiments, the personalized nutritional supplement method is automated. A computer system may be employed that includes a database, is adapted to allow access to the Internet, and is adapted to be accessed via the Internet.

In one or more embodiments, affiliation 102 includes associating one or more pharmacy groups, and registering one or more affiliates from each pharmacy group. Registration information may be entered into the computer system database. Verification that each affiliate has access to the Internet is obtained.

In one or more embodiments, training 104 includes providing the affiliate with a start-up kit. In one or more embodiments, the start-up kit includes information about the method, a training manual, and an access code. In one or more embodiments, training further includes providing the affiliate with an affiliate assessment tool. In one or more embodiments, the affiliate assessment tool includes online functionality to review and modify a client submitted Healthstyle Risk Assessment. In one or more embodiments, training further includes training the affiliate. This includes detailed information in regards to the functionality of the affiliate assessment tool in person, over the phone or by using an online webinar.

In one or more embodiments, client assessment 106 includes the steps of a client accessing an Internet portal by using the access code, answering a series of questions, and sending the answers via e-mail to the affiliate. In one or more embodiments, the series of questions include a healthstyle risk assessment.

In one or more embodiments, the healthstyle risk assessment is based upon personal data, dietary patterns, lifestyle, physical wellbeing, medical conditions, and medications.

Personal data may include but not limited to race, family history, age, gender, and genetic predispositions.

In one or more embodiments, dietary patterns include but not limited to information such as the number of servings of fruit each day, the number of servings of vegetables each day, the amount of processed meats consumed, the number of servings of sugar or natural sweeteners per day, the number of servings of artificial sweeteners per day, the amount of trans fats consumed each week, and the intake of cold water fatty fish.

In one or more embodiments, lifestyle factors include but not limited to the amount of rest received, the amount of alcohol consumed per day, exposure to second hand smoke and tobacco usage. Lifestyle can also include the amount of direct sun exposure received each day, and the amount of exercise.

Physical well-being may include but not limited to overall bone health, joint health, immune system protection, digestive health, and the amount of stress in daily life. Physical well-being may also include the average level of physical and mental energy.

In one or more embodiments, information about medical conditions of the client is included in the assessment. These are chosen from a list of over 230 conditions with known published studies of a medical condition specific—nutritional support; medical condition specific—nutrient interactions; or medical condition specific—nutritional depletion. Examples of medical conditions that are considered are diabetes, osteoporosis, hypertension and rheumatoid arthritis.

In one or more embodiments, information about any regular prescription or over the counter medications that are taken by the client is included in the assessment. These are chosen from a list of over 1900 medications with known published studies of any drug-nutrient interactions or nutritional depletion caused by drugs in association with ingredients in our inventory.

In one or more embodiments, the information received from the client assessment may be stored in the computer system database. The computer system database may also contain information regarding potential interactions between lifestyles choices, foods, medications, and nutritional supplements.

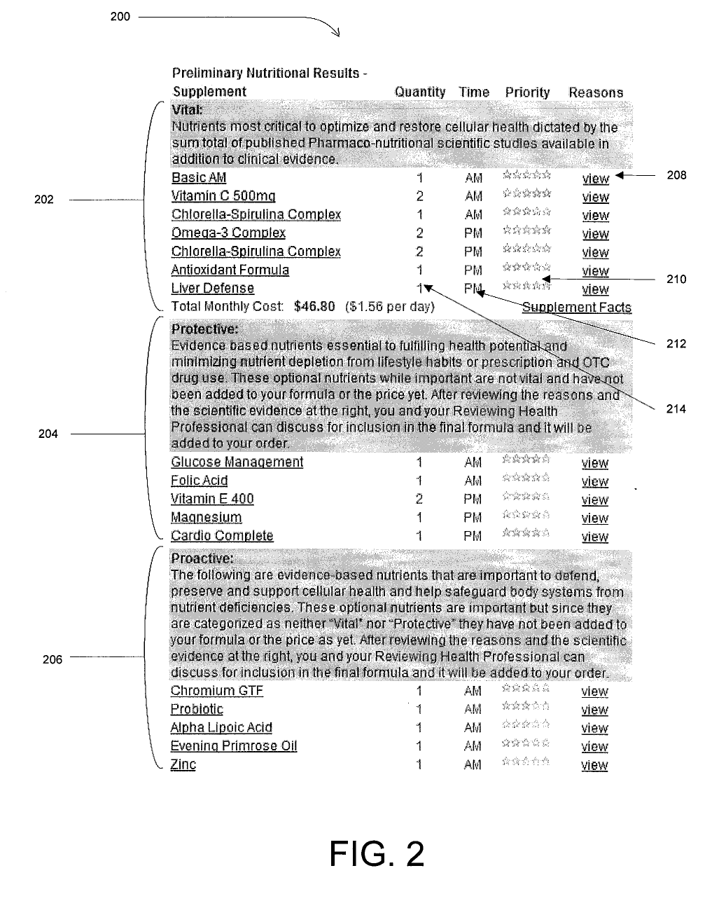

In one or more embodiments, the completed client assessment results in recommendations being generated and communicated. The results may include a preliminary nutritional program as illustrated in FIG. 2. The preliminary nutritional program 200 may include a combination of nutritional agents. Nutritional agents may include vitamins, minerals, essential fatty acids, probiotics and herbal extracts. One or more nutritional agents may be recommended and/or provided as a nutritional supplement. The supplements may include vital supplements 202, protective supplements 204, and proactive supplements 206.

Vital supplements 202 are those nutrients that are most critical to optimizing and restoring cellular health. Vital supplements are pre-determined using random, double-blind placebo controlled human studies including clinical preferences, and this information may be stored in the computer system database. In one or more embodiments, vital supplements may include but not limited to Basic AM, Basic PM, Omega-3 Complex, Liver Defense, and Antioxidant Formula.

Protective supplements 204 are those that evidence has indicated are essential to fulfilling health potential and minimizing nutrient depletion from lifestyle habits or prescription and over the counter drug use. Protective supplements are pre-determined using double-blind, placebo controlled human studies including clinical preferences. Information regarding protective supplements may be stored in the computer system database. In one or more embodiments, protective supplements may include but not limited to Glucose Management, Folic Acid, Cardio Complete, and Magnesium.

Proactive supplements 206 are those that evidence have indicated are important to defend, preserve and support cellular health and help safeguard body systems from nutrient deficiencies. Proactive supplements are pre-determined using pilot studies, trials, human and appropriate animal studies including clinical preferences, and this information may be stored in the computer system database. Proactive nutrients may be considered to be optional nutrients. In one or more embodiments, proactive supplements include Chromium GTF, Probiotic, Alpha Lipoic Acid, Evening Primrose Oil, and Zinc.

Generation of the preliminary nutritional program may include the use of one or more computerized databases and algorithms. These algorithms may be displayed for each supplement, giving a reason why the supplement was recommended, cautioned, blocked or has an advisory. A supplement that is recommended may have studies referenced 208 that support the use of a given supplement based on a given answer. A supplement that is blocked may also have studies referenced that support the block of the given supplement from the preliminary nutritional program. A cautioned supplement may be accompanied by a reason and reference. Also, however the affiliate can still recommend this supplement by overriding the caution and adding the supplement to the preliminary nutritional program.

In one or more embodiments, review 108 of the preliminary nutritional program is conducted by the affiliate or other health professional and any potential interactions between diet, pharmaceutical products, and supplements are identified before the program is provided to the client as a recommended preliminary nutritional program.

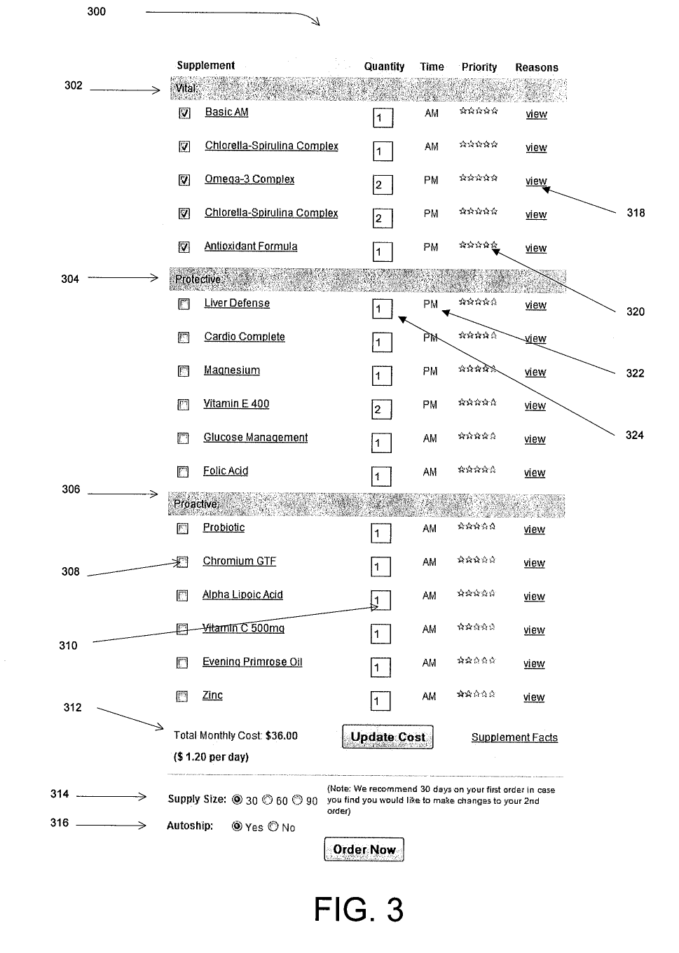

The recommended preliminary nutritional program may be reviewed by the client, and in placing an order, the program may be adjusted, as generally shown in FIG. 3.

The adjustable order form 300 may include much of the same information that is provided in the preliminary nutritional program. That is, the form may include a priority ranking 210, 320 for each supplement. The priority designation for each supplement indicates the relative nutritional importance of that supplement, and results directly from the answers given in the health style risk assessment. In one or more embodiments, the preliminary nutritional program may also include a recommended quantity to be taken for each supplement. Quantity 214, 324 is exemplary of a recommended quantity for a supplement. In one or more embodiments, the preliminary nutritional program may include a recommended time of day for each supplement to be taken. Recommended time of day 212, 322 is exemplary of a recommended time of day in which the supplement should be taken. More specifically, the preliminary nutritional program indicates whether each supplement should be taken with breakfast (AM) or dinner (PM). In one or more embodiments, the preliminary nutritional program includes scientific articles and other evidence for review by the user and the health professional. Hyperlinks 208, 318 are exemplary of the hyperlinks provided for each supplement, wherein the hyperlinks take the reviewer or client to articles and/or other references related to each supplement.

In one or more embodiments, the recommended preliminary nutritional program may be adjusted based upon budgetary considerations. Thus, in one or more embodiments, the preliminary nutritional program includes an estimated monthly cost 312. Based upon this estimated cost, the user can adjust the nutritional program according to budgetary constraints, for example by checking a box (308 is exemplary of a check box such as is provided for each supplement) to select from among the recommended vital 302, protective 304 and 306 supplements or by entering an appropriate numeral in a quantity indicator box (310 is exemplary of a quantity indicator box such as is provided for each supplement).

In one or more embodiments, order placement includes the step of the client reviewing 110 nutrient recommendations and then placing an order 112 through the Internet portal. In one or more embodiments, order placement includes the step of requesting an autoship option 316, shown in FIG. 3.

In one or more embodiments, order fulfillment 114 includes the steps of receiving the client order through the Internet portal, placing the order into a production system, fulfilling the order and shipping the order to the client. The order may be fulfilled by providing one or more packages containing the recommended nutritional supplements. If more than one nutritional supplement is ordered, each supplement may be packaged separately, along with instructions for use. In another embodiment, two or more ordered supplements may be packaged together, with instructions that may include taking the supplements together or separately as appropriate. In another embodiment, two or more ordered supplements may be compounded into one capsule, tablet, or other product. It should be understood that the methods of the present invention provide not only nutritional supplement products, but also a recommended program for their use, which program may also be referred to as a product.

In one or more embodiments, a notification is sent to the affiliate upon shipment of the order. When an autoship option 316 is selected during the order placement, a copy of the order is placed into a recall file. On a periodic basis, selected by the client and indicated on the adjustable order form at 314, additional quantities of the order are shipped to the client. For example, if the client selects a monthly auto ship option, then once a month the order is recalled from the recall file, fulfilled, and shipped to the client.

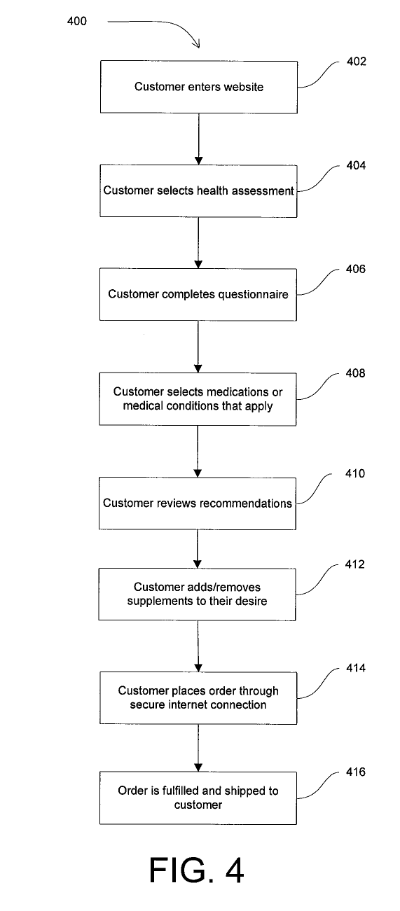

Also provided is a customer-initiated web-based method 400 generally shown in FIG. 4. The customer-initiated method includes the following general steps: 1). Customer enters website 402; 2). the customer selects a health assessment 404; 3). the customer completes the questionnaire 406; 4). the customer indicates any relevant medications and medical conditions 408; 5). the customer receives and reviews the recommended program 410; 6). the customer optionally adds or removes supplements from the program 412; 7). the customer places an order through a secure internet connection 414; and 8). the customer receives the fulfilled order 416.

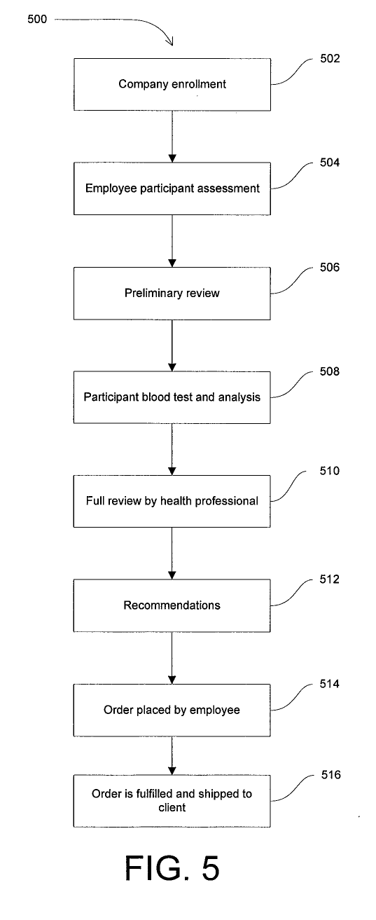

The present invention also provides a personalized nutritional supplement program as generally illustrated by FIG. 5, through a method 500 that includes the following general steps: 1). company enrollment 502; 2). employee participant assessment 504; 3). reviewing said assessment, including preliminary health attributes and inflammation screening data 506; 4). participant blood test and analysis 508; 5). Full review by Health Professional 510; 6). Employee review recommendations 512; 7). order placement 514; and 8). order fulfillment 516.

In one or more embodiments, company enrollment 502 includes the steps of selecting a level of service from a plurality of service plans, selecting a payment plan, providing company data, and providing access codes for company employees. Company data may include appropriate employee eligibility data. The company is provided with access codes for each employee participant.

In one or more embodiments, employee participant assessment 504 includes the steps of a participant accessing an Internet portal by using the access code and answering a series of questions. In one or more embodiments, the series of questions include a healthstyle risk assessment, as described hereinabove, and inflammation screening data. In one or more embodiments, information received during employee participant assessment may be stored in the computer system database.

Employee participant assessment includes the steps of a participant answering a series of yes/no questions that are used to determine an inflammation score by a health professional. An inflammation score is determined, by the number of “no” versus “yes” answers. If the inflammation score is relatively low, further testing and review is optional, and recommendations are communicated to the participant. In one or more embodiments, where the inflammation score is about 1 or less, further testing and review is optional. Therefore, in one or more embodiments, the step of preliminary review 506 results in recommendations being generated and communicated. The results may include a preliminary nutritional program recommendation. The preliminary nutritional program may include a recommended combination of nutritional supplements, as described hereinabove.

In one or more embodiments, where the inflammation score is relatively high, further testing and a complete review is conducted. In one or more embodiments, where the inflammation score is greater than about 1, the method of the present invention comprises participant blood testing 508.

In one or more embodiments, participant blood testing includes drawing one or more blood samples, testing the blood, and obtaining results. In one or more embodiments, the participant blood sample may be drawn by the company, by a phlebotomist, or by a testing lab. If the blood sample is drawn by the company or a phlebotomist, the sample may be sent to a testing lab for testing.

In one or more embodiments, multiple blood samples are drawn from a participant, depending upon the level of service selected by the company. In one or more embodiments, three vials of blood are drawn from each participant, and tested for oxidative LDL, Hs C-Reactive Protein, fibrinogen, serum glucose, HbAlc, Apo (B), homocysteine, fasting insulin, Lp (a), vitamin D 25-hydroxy and lipid panel. In one or more embodiments, four vials of blood are drawn from each participant, and tested for oxidative LDL, Hs C-Reactive Protein, fibrinogen, serum glucose, HbAlc, Apo (B), homocysteine, fasting insulin, Lp (a), vitamin D, 25-hydroxy, lipid panel, interlukin-6, magnesium RBC, TNF Alpha and Apo (A). In one or more embodiments, five vials of blood are drawn from each participant, and tested for oxidative LDL, Hs C-Reactive Protein, fibrinogen, serum glucose, HbAlc, Apo (B), homocysteine, fasting insulin, Lp (a), vitamin D 25-hydroxy, lipid panel, interlukin-6, magnesium RBC, TNF Alpha, Apo (A) and AA/EPA

In one or more embodiments, the blood samples are tested by a testing lab and the results are uploaded into the computer system database.

Once the participant assessment and blood test results are received, a preliminary nutritional program 200 can be generated. The preliminary nutritional program may include a recommended combination of nutritional agents, as described hereinabove. In one or more embodiments, the preliminary nutritional program includes one or more recommended nutritional supplements, recommended dosage levels for said supplements, and recommended dosage regimens for said supplements.

In one or more embodiments, the step of generating a preliminary nutritional program includes the use of one or more computerized databases and algorithms combined with data from the participant assessment and results from the blood testing. The algorithms that are employed in generating the program are displayed to the reviewer for each mentioned supplement, giving a reason why the supplement was recommended, cautioned, blocked or has an advisory. Generally, a supplement that is suggested for inclusion in the preliminary has studies referenced that support the use of a given supplement based on a given answer. A supplement that is blocked also has studies referenced that support the block of the given supplement from the preliminary nutritional program. A cautioned supplement has a reason and reference also however the affiliate can still recommend this supplement by overriding the caution and adding the supplement to the preliminary nutritional program.

The preliminary nutritional program may be transmitted to a reviewer who is a health care professional, who reviews the preliminary nutritional program. The reviewer can approve and recommend the program, or can amend and then recommend the program. The step of full review 510 includes a health professional reviewing and screening the output from the computerized databases and algorithms. Once the health professional approves the program, it is recommended to the participant 512.

The recommendations may be communicated to the participant by the company, or via an Internet portal. Depending upon the level of service selected by the company, the recommendations may be communicated to the participant during a consultative meeting. In one or more embodiments, one or more health care professionals may be present during the consultative meeting.

Based upon the recommendations communicated to the participant, the participant may place an order 514 for one or more nutritional agents. Therefore, in one or more embodiments, the method further comprises the steps of order placement and order fulfillment 516 described hereinabove.

Various modifications and alterations that do not depart from the scope and spirit of this invention will become apparent to those skilled in the art. This invention is not to be duly limited to the illustrative embodiments set forth herein.

What is claimed is:

1. An automated method for providing a personalized nutritional supplement product to a client comprising:
constructing a computer system adapted to be accessed via the Internet and having a database;
registering an affiliate;
providing a start-up kit to said affiliate, wherein said start-up kit includes access to the computer system via the Internet;
acquiring a client and receiving current client health attributes from the client or from the client's health provider;
storing in the computer system database said client health attributes;
storing in the computer system database potential interactions between lifestyle choices, foods and/or medications with nutritional supplements;
generating a preliminary nutritional program, wherein said program includes one or more recommended nutritional supplements, recommended dosage levels for said supplements, and recommended dosage regimens for said supplements;
requesting said affiliate to review said client health attributes, said potential interactions, and to review and recommend said preliminary nutritional program;
transmitting said recommended preliminary nutritional program to the client;
receiving an order from the client for one or more of said recommended nutritional supplements that were recommended in said preliminary nutritional program;
preparing a final nutritional program that includes the ordered nutritional supplements, recommended dosage levels for said ordered supplements, and recommended dosage regimens for said ordered supplements;
fulfilling said order; and
transmitting said final nutritional program to the client.

2. The method of claim 1, wherein said client health attributes include one or more of personal data, dietary patterns, lifestyle, physical wellbeing, medical conditions, and medications.

3. The method of claim 1, wherein the start-up kit includes information about the method, a training manual, and an access code.

4. The method of claim 1, wherein said step of acquiring a client includes the steps of verifying that the client has access to the Internet, and providing an access code to the client.

5. The method of claim 1, wherein receiving current client health attributes includes receiving answers to a series of questions.

6. The method of claim 1, wherein said preliminary nutritional program classifies said recommended nutritional supplements as vital, protective, or proactive supplements.

7. The method of claim 6, wherein said vital supplements include nutrients that are critical to optimizing and restoring cellular health.

8. The method of claim 6, wherein said vital supplements are pre-determined using random, double-blind placebo controlled human studies including clinical preferences.

9. The method of claim 6, wherein said protective supplements include nutrients that minimize nutrient depletion from lifestyle habits or medications.

10. The method of claim 6, wherein said protective supplements are pre-determined using double-blind, placebo controlled human studies including clinical preferences.

11. The method of claim 6, wherein proactive supplements are pre-determined using pilot studies, trials, human and appropriate animal studies including clinical preferences.

12. The method of claim 1, wherein said step of review includes the step of requesting a review by a health professional.

13. An automated method for providing a personalized nutritional supplement program to a participant comprising:
constructing a computer system adapted to be accessed via the Internet and having a database;
enrolling a company having one or more employee participant;
providing the participant with access to the computer system via the Internet;
receiving preliminary participant health attributes from a participant, including participant inflammation screening data;
reviewing said preliminary health attributes and inflammation screening data;
ordering participant blood testing;
receiving participant blood test results;
storing in the computer system database said participant health attributes, inflammation screening data, and participant blood test results;
storing in the computer system database potential interactions between foods, medications, and nutritional supplements and algorithms for relating blood analysis to diet, medications, and nutrition;
generating a recommended preliminary nutritional program, wherein said step of generating is based upon said stored participant health attributes, inflammation screening data, blood test results, potential interactions, and said algorithms, and wherein said program includes one or more recommended nutritional supplements, recommended dosage levels for said supplements, and recommended dosage regimens for said supplements;
optionally transmitting said recommended preliminary nutritional program to a reviewer who is a health care professional, and who reviews the preliminary nutritional program and can approve or amend the program;
transmitting the reviewed nutritional program to the client;
receiving an order from the client for one or more of said recommended nutritional supplements that were recommended in said reviewed preliminary nutritional program;
preparing a final nutritional program that includes the ordered nutritional supplements, recommended dosage levels for said ordered supplements, and recommended dosage regimens for said ordered supplements;
fulfilling said order; and
transmitting said final nutritional program to the client.

14. The method of claim 13, wherein said step of enrolling a company includes one or more of selecting a level of service from a plurality of services plans, selecting a payment plan, and receiving company data.

15. The method of claim 13, wherein receiving current client health attributes and inflammation screening data includes receiving answers to a series of questions.

16. The method of claim 13, wherein said blood testing includes one or more tests for oxidative LDL, Hs C-Reactive Protein, fibrinogen, serum glucose, HbAlc, Apo (B), homocysteine, fasting insulin, Lp (a), vitamin D 25-hydroxy or lipid panel.

17. The method of claim 13, wherein said blood testing includes one or more tests for oxidative LDL, Hs C-Reactive Protein, fibrinogen, serum glucose, HbAlc, Apo (B), homocysteine, fasting insulin, Lp (a), vitamin D, 25-hydroxy, lipid panel, interlukin-6, magnesium RBC, TNF Alpha, Apo (A) or AA/EPA.

18. The method of claim 13, wherein said preliminary nutritional program classifies said recommended nutritional supplements as vital, protective, or proactive supplements.

19. The method of claim 16, wherein said vital supplements include nutrients that are critical to optimizing and restoring cellular health.

20. The method of claim 13, wherein said protective supplements include nutrients that minimize nutrient depletion from lifestyle habits or medications.

21. A computer system for providing a personalized nutritional supplement product, the system comprising:
a database, wherein said database includes potential interactions between diet, pharmaceutical products, and supplements,
an interface adapted to receive input of client health attributes from a client,
a processor adapted to employ rules for relating client health attributes to database content and calculate optimum combinations of nutritional supplements, optimal dosage levels and optimal dosage regimen;
an output adapted to display and transmit.

22. The computer system of claim 21, wherein said interface is further adapted to receive input of blood test results from a testing center.
